(19) United States
(12) Patent Application Publication
(10) Pub. No.: US 2010/0119275 A1
(43) Pub. Date: May 13, 2010

(54) IMAGE FORMING APPARATUS

(75) Inventors: Masumi Akiyama, Osaka-shi (JP); Hiroshi Ishida, Osaka-shi (JP); Takaya Akiyama, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/691,792

(22) Filed: Jan. 22, 2010

Related U.S. Application Data
(62) Division of application No. 11/364,601, filed on Feb. 27, 2006.

(30) Foreign Application Priority Data
Feb. 28, 2005 (JP) 2005-054994
Jan. 26, 2006 (JP) 2006-017145

(51) Int. Cl. G03G 15/00

(52) U.S. Cl. 399/405

(57) ABSTRACT

An image forming apparatus has a main body (11). A side wall (12) extends up at one side of the main body (11) while a rear wall (13) extends up at the rear of the main body (11). A document reader (14) is disposed atop the side wall (12) and the rear wall (13), and a discharging unit is defined between the document reader (14) and the main body (11). A discharge tray (16) is provided in the discharging unit for receiving recording sheets after printing, and a sheet storing portion (18) is formed between the upper surface of the main body (11) and the discharge tray (16). The sheet storing portion (18) has an opening at least at the front opposite to the rear wall (13), and the recording sheet is held to project out through the opening upon being stored into the sheet storing portion (18).

### CROSS-REFERENCE TO RELATED APPLICATIONS

This application is a divisional of U.S. patent application Ser. No. 11/364,601, filed Feb. 27, 2006.

### BACKGROUND OF THE INVENTION

1. Field of the Invention

The present invention relates to an image forming apparatus adopting an electrophotographic process such as a copier, a printer or a facsimile apparatus and particularly to a construction of a discharging unit to which a recording sheet is discharged after printing.

2. Description of the Related Art

Generally, in an image forming apparatus such as a copier, a printer or a facsimile apparatus, a recording sheet (hereinafter, referred to merely as a sheet in some cases) after printing (image formation) is discharged to a discharging unit such as a discharge tray, and a user removes the sheet from the discharging unit after printing. However, in the case of printing many sheets, it takes a certain time to print. Thus, the user often performs another operation by leaving the image forming apparatus during printing, goes back to the image forming apparatus at a suitable timing when the printing is completed, and removes the sheets from the discharging unit.

However, upon conducting another operation or the like by leaving the image forming apparatus, the user may forget the printing is in process, with the result that the printed sheets may be left in the discharging unit even after the printing is completed. If the sheets are left in the discharging unit, sheets are discharged on the sheets left in the discharging unit when another user performs a next printing operation and it is cumbersome to sort the sheets.

It is not necessary to sort the sheets if the next user performs the printing operation after removing the sheets left in the discharging unit, but the users are often perplexed as to where they should place the removed sheets and it is sometimes difficult to handle the removed sheets if it is unknown to whom the removed sheets belong.

Japanese Unexamined Patent Publication No. 2001-206609 discloses that a discharging unit is set in a space defined between a scanner unit and a main body of an image forming apparatus and a box-shaped discharge tray having no lid is provided in this discharging unit. This box-shaped discharge tray is made displaceable between a state where it is accommodated in the discharging unit and a state where it is withdrawn from the discharging unit by being rotated in forward and reverse directions about a specified supporting shaft. A side wall of the box-shaped discharge tray facing the outside is made of a transparent material, so that the inside of the box-shaped discharge tray can be visually confirmed through this transparent side wall.

However, in the image forming apparatus disclosed in the above publication, visibility is improved merely by making the side plate of the transparent material and efficiency in taking out recording sheets placed on the discharge tray is improved by making the discharge tray movable. Accordingly, as described above, if the printed sheets are left in the discharging unit even after the completion of the printing, a user performing the printing operation next is perplexed as to how to handle the sheets, wherefore a problem of being unable to properly perform his own printing operation is not solved.

Accordingly, it may be thought to place a suitable table adjacent to the image forming apparatus and to transfer the left printed sheets to the table if the printed sheets are left in the discharging unit. However, such an arrangement not only increases an equipment cost by necessitating the special table, but also requires an extra space for this table, thereby presenting a new problem of narrowing a working space by this extra space.

### SUMMARY OF THE INVENTION

In view of the problems residing in the prior art, an object of the present invention is to provide an image forming apparatus constructed such that a next user can immediately perform the printing operation even if printed sheets are left in a discharging unit and a user having left the sheets in the discharging unit can easily see the presence of his/her own sheets.

In order to accomplish this object, the invention is directed to an image forming apparatus, comprising a main body accommodating at least an image forming unit and a fixing unit; a discharging unit including a discharge tray onto which a recording sheet is discharged after an image is formed thereon in the main body; and a sheet storing portion formed between the upper surface of the main body and the discharge tray for accommodating at least a part of the recording sheet to thereby hold the recording sheet; wherein the sheet storing portion has a specified opening for allowing the recording sheet to be stored into and removed from the sheet storing portion thought the opening.

Since the image forming apparatus according to the present invention is provided with the sheet storing portion as above, even if a previous user left the recording sheet on the discharge tray, a next user can store the left recording sheet in the sheet storing portion and lets the image forming apparatus perform an image forming operation such as a copying operation. Accordingly, it does not take time to sort recording sheets, thereby improving operability. Particularly, if the sheet storing portion can hold the recording sheet while letting part of the recording sheet project through the opening, the presence of the recording sheet in the sheet storing portion can be easily seen. As a result, an effect of enabling the previous user to notice that he/she forgot to remove the recording can also be expected.

These and other objects, features, aspects and advantages of the present invention will become more apparent upon a reading of the following detailed description and accompanying drawings.

### BRIEF DESCRIPTION OF THE DRAWINGS

FIG. 1 is a perspective view of an image forming apparatus according to a first embodiment of the invention.

FIG. 2 is a perspective view of an image forming apparatus according to a second embodiment of the invention.

FIG. 3 is a section along the line I-I in FIG. 2 showing a state where a discharge tray is set in a horizontal posture.

FIG. 4 is a section along the line I-I in FIG. 2 showing a state where a discharge tray is set in an inclined posture.

FIG. 5 is a perspective view of an image forming apparatus according to a third embodiment of the invention.

FIG. 6 is a perspective view of an image forming apparatus according to a fourth embodiment of the invention.

FIG. 7 is a side view of an image forming apparatus according to a fifth embodiment of the invention.

FIGS. 8A and 8B are perspective views of an image forming apparatus according to a sixth embodiment of the invention, wherein FIG. 8A shows a state where a discharge tray is set at a lower level and FIG. 8B shows a state where the discharge tray is set at an upper level.

FIG. 9 is a perspective view of an image forming apparatus according to a seventh embodiment of the invention.

FIG. 10 is a perspective view of an image forming apparatus according to an eighth embodiment of the invention.

FIG. 11 is a perspective view of an image forming apparatus according to a ninth embodiment of the invention.

FIG. 12 is a perspective view of an image forming apparatus according to a tenth embodiment of the invention.

FIG. 13 is a perspective view of an image forming apparatus according to an eleventh embodiment of the invention.

### DETAILED DESCRIPTION OF THE PREFERRED EMBODIMENTS

Hereinafter, preferred embodiments of the present invention are described in detail by way of examples with reference to the accompanying drawings. It should be noted that the dimensions, materials, shapes and relative arrangement of parts disclosed in these embodiments do not restrict the scope of the present invention and are merely examples unless particularly specified.

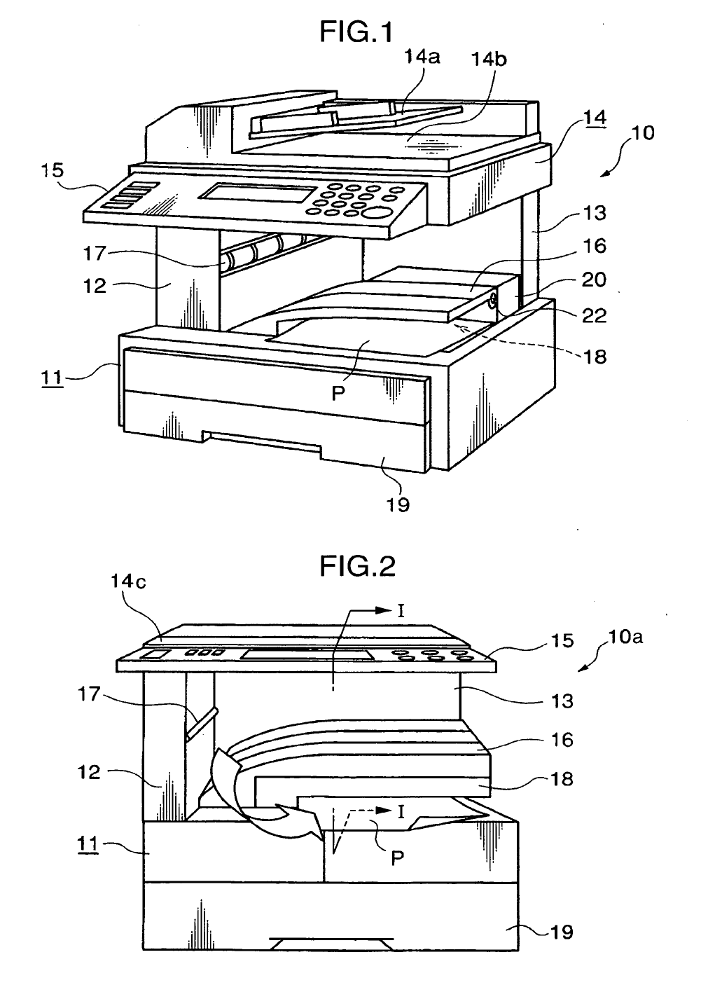

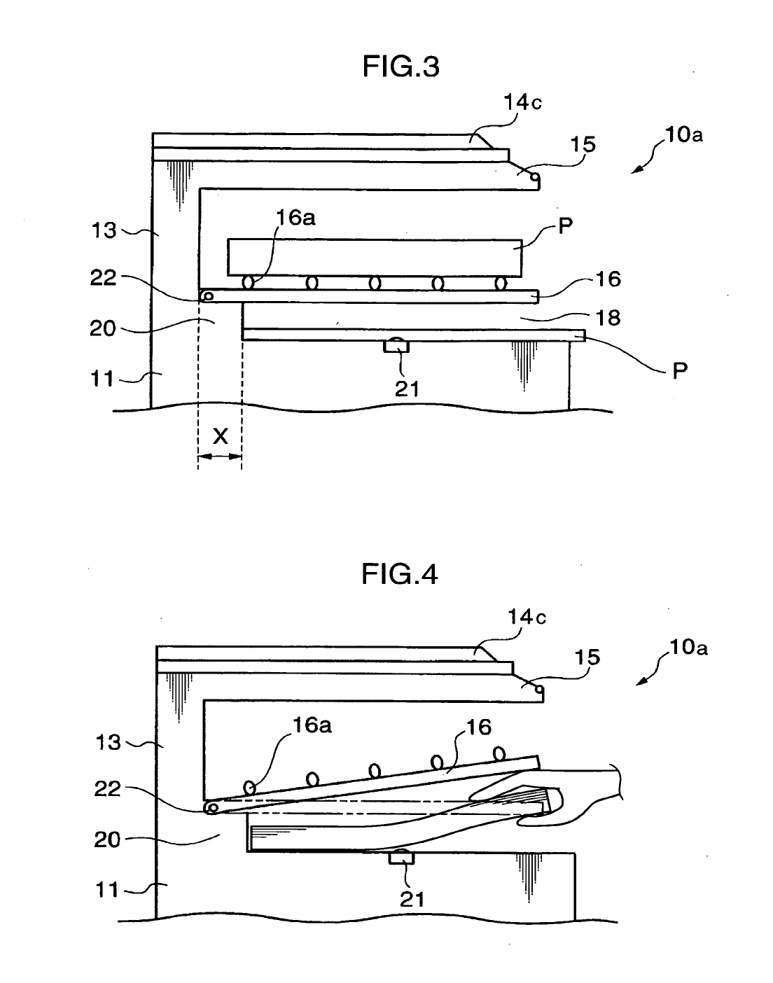

FIG. 1 is a perspective view of an image forming apparatus 10 (copier) according to a first embodiment of the present invention and FIG. 2 is a perspective view of an image forming apparatus 10a according to a second embodiment of the present invention. FIGS. 3 and 4 are sections along the line I-I in FIG. 2 showing a state where a discharge tray 16 is set in a horizontal posture and a state where the discharge tray 16 is set in an inclined posture, respectively. As shown in these Figures, each of the image forming apparatuses 10, 10a of the first and second embodiments is provided with a main body 11 for performing an image forming operation, a document reader 14 arranged above the main body 11, and a discharging unit disposed to define an open space portion for removing sheets between the main body 11 and the document reader 14.

An image forming unit (not shown), a fixing unit (not shown) and the like are accommodated in the main body 11. A side wall portion 12 extending upward is integrally mounted on the left side surface (one side surface) of the main body 11 in FIGS. 1 and 2, and a rear surface portion 13 is integrally mounted on the rear surface of the main body 11. A sheet discharging path (not shown) extending from the main body 11 to the document reader 14 to be described later is formed in the side wall portion 12.

The document reader 14 is arranged atop the side wall portion 12 and the rear surface portion 13, and an operation panel 15 is mounted on the front surface of the document reader 14. In the image forming apparatus 10 of the first embodiment, an automatic document feeder for automatically dispensing documents one by one from a bundle of documents and allowing the documents to be read one by one is used as the document reader 14 as shown in FIG. 1. On the other hand, in the image forming apparatus 10a of the second embodiment, the document reader 14 is provided with a document pressing cover 14c for simply pressing a document against an unillustrated contact glass as shown in FIG. 2 instead of the automatic document feeder.

A space is defined between the document reader 14 and the main body 11 because of the presence of the side wall portion 12 and the rear surface portion 13, and this space serves as the discharging unit for receiving sheets P discharged from the main body 11 by way of the side wall portion 12. In these embodiments, a front side opposite to the rear surface portion 13 and a right side opposite to the side wall portion 12 serve as open space portions used to remove the sheets. Specifically, the image forming apparatuses 10, 10a of the first and second embodiments are both of the so-called internally discharging type in which the discharging unit is formed between the main body 11 and the document reader 14. The discharge tray 16 is provided in such a discharging unit. In other words, the discharge tray 16 is provided on the upper surface of the main body 11, and sheets P are discharged thereonto through a discharge opening 17 formed in the side wall portion 12.

A sheet storing portion 18 is provided between the discharge tray 16 and the upper surface of the main body 11. This sheet storing portion 18 is formed by a space between the upper surface of the main body 11 and the discharge tray 16 obtained by curving the discharge tray 16 obliquely upward from the bottom of the side wall portion 12. Printed sheets are stored in such a sheet storing portion 18.

Upon forming an image (i.e. copying) in the image forming apparatus 10 of the first embodiment, when a bundle of documents are placed on a document tray 14a of the document reader 14 and a copy button on the operation panel 15 is pressed, the documents are automatically dispensed one by one from the document bundle on the document tray 14a and have images thereof successively read. The documents having the images thereof read are discharged onto a document discharge tray 14b located below the document tray 14a.

Contrary to this, in the image forming apparatus 10a of the second embodiment, after the unillustrated contact glass is exposed by opening the document pressing cover 14c openably and closably provided on the upper surface of the document reader 14 and the document is placed faced down on the contact glass, the document pressing cover 14c is closed and the image of the document is read in this state.

On the other hand, sheets are fed from a sheet cassette 19 provided in a bottom part of the main body 11 to the image forming unit via a sheet feeding path (not shown). To the sheet fed to the image forming unit is transferred a toner image obtained by an electrophotographic process based on an image data obtained by reading the document. The sheet having the toner image transferred thereto is discharged onto the discharge tray 16 through the discharge opening 17 through the sheet discharging path after reaching the fixing unit through a sheet conveying path and having the toner image fixed thereto in the fixing unit.

As described above, if a previous user does not remove the sheet from the discharge tray 16 after letting the image forming apparatus 10, 10a perform the copying operation or the like, i.e. if the previous user forgets to remove the sheet, a next user needs to place the sheet on the discharge tray 16 somewhere. This is because it may be cumbersome to sort if a copying operation is performed with the sheet left placed on the discharge tray 16. Accordingly, if the sheet P printed by the previous user is left on the discharge tray 16 when the next user performs a copying operation, the next user can remove the sheet P from the discharge tray 16 and temporarily store it in the sheet storing portion 18 located below the discharge tray 16 as indicated by an outline arrow in FIG. 2.

As shown in FIGS. 1 and 2, the sheet storing portion 18 has openings at front and right (other side) sides respectively opposite to the rear surface portion 13 and the side wall portion 12 in conformity with the open areas used to remove the sheet in the discharging unit. Accordingly, the next user can easily insert the sheet P on the discharge tray 16 into the sheet storing portion 18 through these openings. Further, the previous user can easily take the sheet P out from the sheet storing portion 18 through these openings.

In the image forming apparatus 10a of the second embodiment, a plurality of ribs 16a elongated in a sheet discharging direction as shown in FIGS. 2 to 4 are provided on the upper surface of the discharge tray 16. By providing such ribs 16a, fingers can be inserted into a clearance defined between the sheet P and the upper surface of the discharge tray 16 because of the presence of the ribs 16a upon removing the sheet P from the discharge tray 16 by the hand, wherefore the sheet P can be more easily removed from the discharge tray 16.

The sheet storing portion 18 is constructed to hold the sheet P such that part of the sheet P projects from the aforementioned openings. Specifically, a block 20 is provided on the upper surface of the main body 11 at a position opposite to the front opening of the sheet storing portion 18 (at the side of the rear surface portion 13). This block 20 projects toward the discharge tray 16 from the bottom part of the rear surface portion 13, and the upper surface thereof extends in flush with the upper surface of the discharge tray 16 toward the side wall portion 12. When the sheet P is discharged onto the discharge tray 16, the front end (front side with respect to the plane of FIG. 2) of the sheet P is located closer to the rear surface portion 13 than the front end of the operation panel 15.

On the other hand, when the sheet P is stored in the sheet storing portion 18 to bring the rear end of the sheet P into contact with the block 20, the front end of the sheet P projects forward from the main body 11. In order to attain such a state, a distance (interval) X between the front surface of the rear surface portion 13 and the front surface of the block 20 is set such that the front end of the sheet P stored in the sheet storing portion 18 projects forward from the main body 11 with the rear end of the sheet P held in contact with the block 20 as shown in FIG. 3.

If the sheet P is stored in the sheet storing portion 18 in this way, the presence of the sheet P in the sheet storing portion 18 can be easily visually confirmed since the front end of the sheet P projects forward from the upper surface of the main body 11. As a result, the previous user can easily notice that he/she forgot to remove the sheet P. Further, if the discharge tray 16 is made of a transparent material, the presence of the sheet P in the sheet storing portion 18 can be easily known in cooperation with the front and right openings of the sheet storing portion 18.

In addition, a sensor switch 21 (detecting sensor) for detecting the presence or absence of the sheet on the upper surface of the main body 11 and notifying means for making a specified notification in accordance with the detection result of the sensor switch 21 may be provided as shown in FIG. 3. For example, whether or not the sheet has been stored in the sheet storing portion 18 may be detected based on the on/off-information from the sensor switch 21. If the on-information is outputted from the sensor switch 21, an unillustrated controller may turn on an unillustrated sheet-removal urging lamp (notifying means) provided at a specified position of the operation panel 15. By adopting such a construction, the presence of the recording sheet forgotten to be removed can be more easily recognized.

Further, as shown in FIGS. 1, 3 and 4, an end of the discharge tray 16 at the side of the rear surface portion 13 is supported on a shaft member 22 to be rotatable relative to the block 20. In other words, the discharge tray 16 is rotatably supported at the end thereof opposite to the front opening of the sheet storing portion 18. Accordingly, if the discharge tray 16 is lifted upward by gripping the front side (right side in FIG. 4) of the discharge tray 16, the discharge tray 16 is rotated counterclockwise of FIG. 4 about the shaft member 22. Thus, upon removing the sheet stored in the sheet storing portion 18, the discharge tray 16 is rotated about the shaft member 22 by gripping the front side of the discharge tray 16 and lifting up the discharge tray 16, whereby the sheet storing portion 18 is completely exposed and the sheet can be easily removed from the sheet storing portion 18.

If the user inserts his hand through the front opening (inserts fingertips between the upper surface of sheets P and the lower surface of the discharge tray 16) to grip ends of the sheets P as schematically shown in FIG. 4 upon removing the sheets P from the sheet storing portion 18, the discharge tray 16 is rotated upward due to the interference of the hand with the discharge tray 16 at this time, thereby widening the front opening. Accordingly, it is possible to remove the sheets P from the sheet storing portion 18 while opening the discharge tray 16 by one hand without using both hands.

As described above, by rotatably supporting the discharge tray 16 at the end opposite to the opening, this opening is widened if the discharge tray 16 is rotated upward upon removing the recording sheets P from the sheet storing portion 18. Therefore, there is an advantage of being able to easily remove the sheets P from the sheet storing portion 18.

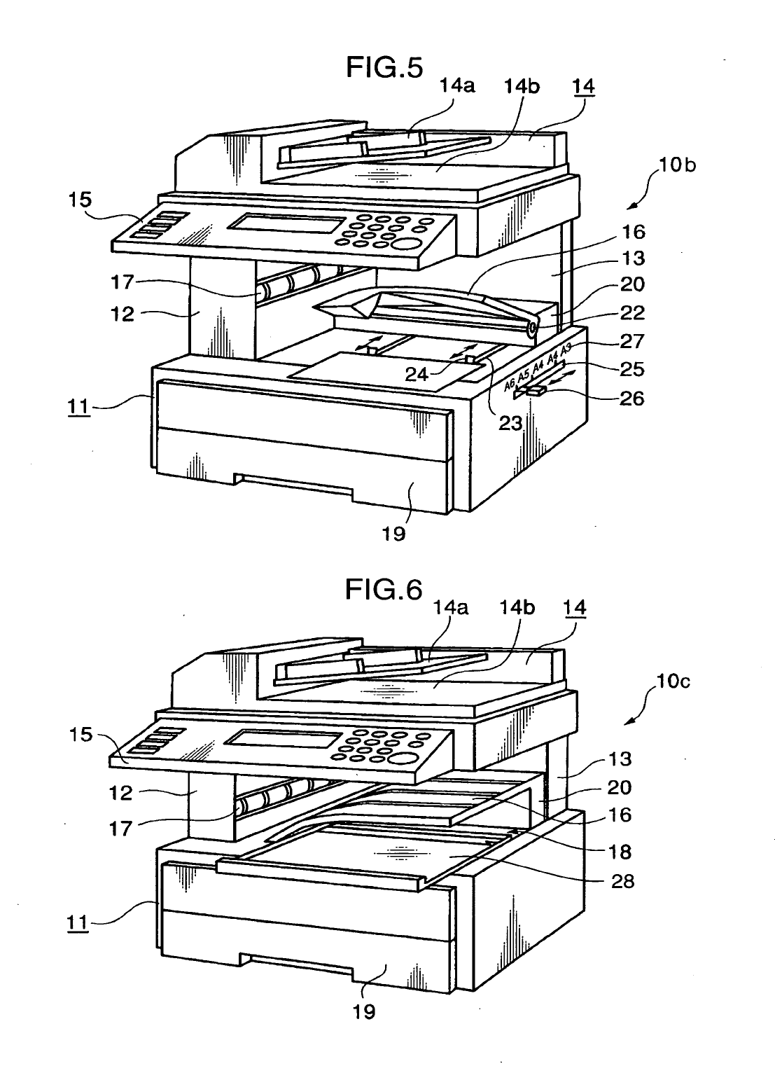

FIG. 5 is a perspective view of an image forming apparatus 10b according to a third embodiment of the present invention. As shown in FIG. 5, a pair of guiding portions extending from the rear side toward the front side (extending in a direction toward a front opening of the sheet storing portion 18) and cursors 24 arranged to be movable along this pair of guiding portions 23 are provided on the upper surface of the main body 11. The rear end of a sheet is brought into contact with the cursors 24.

On the other hand, an oblong guiding hole 25 extending from the rear side toward the front side is formed in the right surface of the main body 11 in FIG. 5, and an operation lever 26 (lever) is so disposed in the oblong guiding hole 25 as to be movable along the oblong guiding hole 25. When the operation lever 26 is moved along the oblong guiding hole 25, the aforementioned cursors 24 are moved while being guided by the guiding portions 23.

Symbol marks 27 representing sheet sizes (A3, A4, etc.) are attached at positions above the oblong guiding hole 25. If a sheet is stored in the sheet storing portion 18 after the operation lever 26 is aligned with the symbol mark of the size of the sheet to be stored, the rear end of the sheet comes into contact with the cursors 24 and the front end thereof projects forward (front side with respect to the plane of FIG. 5) from the main body 11. If the operation lever 26 is maneuvered in accordance with the sheet size to move the cursors 24 (to position the cursors 24) in this way, the front end of the sheet can be caused to project forward from the upper surface of the main body 11 upon storing the sheet in the sheet storing portion 18 regardless of the sheet size. Therefore, a user can easily recognize the presence of the sheet.

FIG. 6 is a perspective view of an image forming apparatus 10c according to a fourth embodiment of present invention. As shown in FIG. 6, a sheet tray 28 is disposed at the bottom of the sheet storing portion 18 in the image forming apparatus 10c of the fourth embodiment. This sheet tray 28 is so disposed on the upper surface of the main body 11 as to be movable relative to the upper surface of the main body 11, and is withdrawal in a direction toward a front opening of the sheet storing portion 18 (toward the front side with respect to the plane of FIG. 6).

By adopting such an arrangement, it is sufficient to withdraw the sheet tray 28 toward the front side or the right side in FIG. 6 upon removing a sheet from the sheet storing portion 18 even if the discharge tray 16 is not made rotatable. Thus, the sheet can be easily removed from the sheet storing portion 18 by a simple construction.

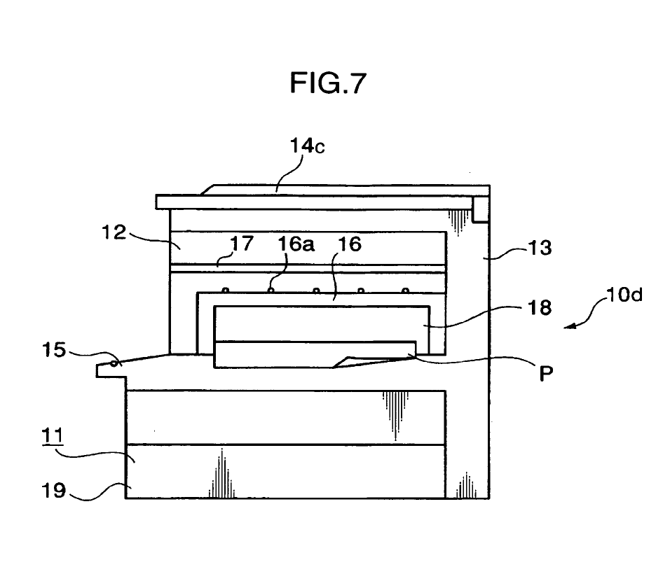

FIG. 7 is a side view in section of an image forming apparatus 10d according to a fifth embodiment of the present invention. In the image forming apparatus 10d of the fifth embodiment, the operation panel 15 is so provided on the main body 11 as to project forward (leftward in FIG. 7) as shown in FIG. 7. In such a case, an opening of the sheet storing portion 18 is formed only at the right side of the image forming apparatus 10d (front side with respect to the plane of FIG. 7), wherein a sheet P is stored into and removed from the sheet storing portion 18 through this opening.

In this case, a block (not shown) with which the leading end of the sheet P comes into contact to let the rear end thereof projects from the right side of the sheet storing portion 18 when the sheet P is stored into the sheet storing portion 18 is desirably provided at a side of the sheet storing portion 18 toward the side wall portion 12. This enables the sheet P stored in the sheet storing portion 18 to be easily recognized.

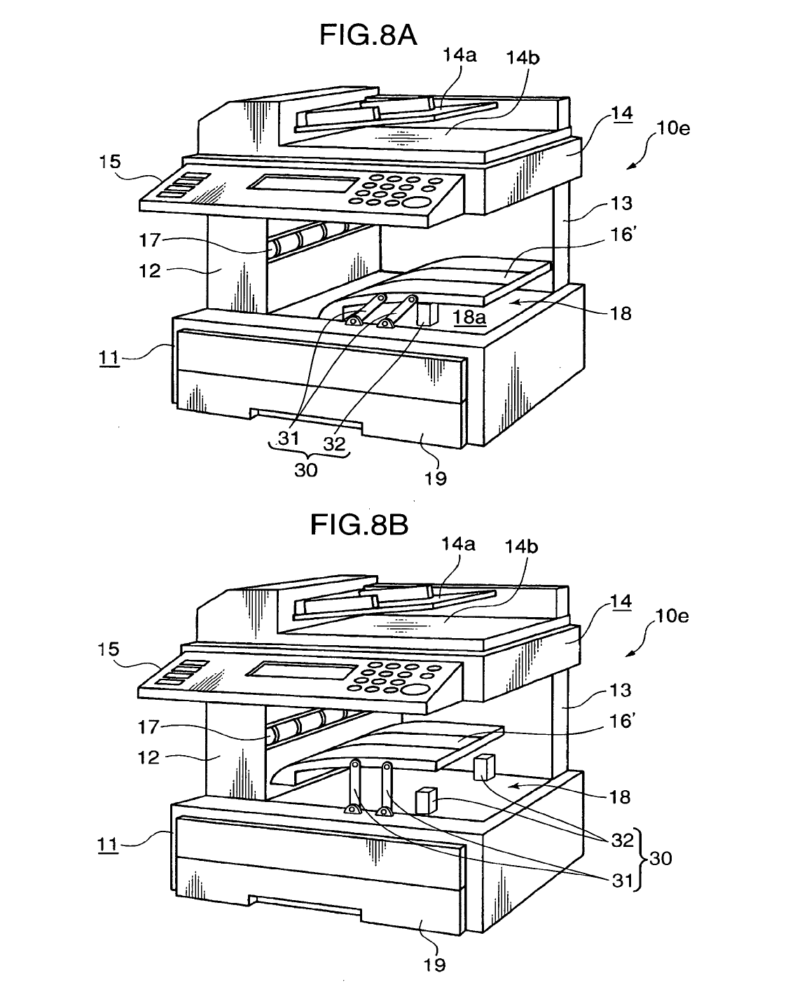

FIGS. 8A and 8B are perspective views of an image forming apparatus 10e according to a sixth embodiment of the present invention, wherein FIG. 8A shows a state where a discharge tray 16′ is set at a lower level and FIG. 8B shows a state where the discharge tray 16′ is set at an upper level. In the sixth embodiment, a rectangular linking structure 30 (linking mechanism) is provided between the discharge tray 16′ and a bottom plate 18a (that is actually the upper surface of the main body 11, but it is so expressed by considering the sheet storing portion 18 as a main element and this also holds for the following description) of the sheet storing portion 18. The height of the discharge tray 16′ is changeable between the lower level and the upper level by the action of this rectangular linking structure 30 while the discharge tray 16′ is held in a horizontal posture.

The rectangular linking structure 30 includes two pairs of link arms 31 having the same effective length and stretching in parallel between the discharge tray 16′ and the bottom plate 18a of the sheet storing portion 18 at the base end side (left side in FIG. 8) of the discharge tray 16′ (in FIG. 8, only the pair of link arms 31 at the front side are shown, whereas the pair of link arms 31 provided at the rear side are not shown).

Accordingly, by pushing the discharge tray 16′ toward the side wall portion 12 so as to raise the respective link arms 31 with the discharge tray 16′ set at the lower level as shown in FIG. 8A, the discharge tray 16′ is set to the upper level as shown in FIG. 8B by the counterclockwise rotation of the respective link arms 31 about their supporting points. Further, by pulling the discharge tray 16′ in a direction away from the side wall portion 12 with the discharge tray 16′ set at the upper level as shown in FIG. 8B, the discharge tray 16′ is rotated clockwise about their supporting points to be returned to the lower level as shown in FIG. 8A.

In this embodiment, stoppers 32 with which the discharge tray 16′ comes into contact project at specified positions of the bottom plate 18a, and the discharge tray 16′ does not move any further downward by the contact with the stoppers 32 while being set at the lower level. The discharge tray 16′ is normally set at the lower level as shown in FIG. 8A, and displaced to the upper level, for example, when sheets are stored into or removed from the sheet storing portion 18 or when too many sheets are stored into the sheet storing portion 18.

According to such an image forming apparatus 10e of the sixth embodiment, the discharge tray 16′ is constantly held in the horizontal posture regardless of the level change. Thus, the removability and the like of the sheets stored in the sheet storing portion 18 can be improved by changing the height of the discharge tray 16′, whereas the sheet(s) P discharged onto the discharge tray 16′ can be effectively prevented from coming off the discharge tray 16′ even if the level of the discharge tray 16′ is changed.

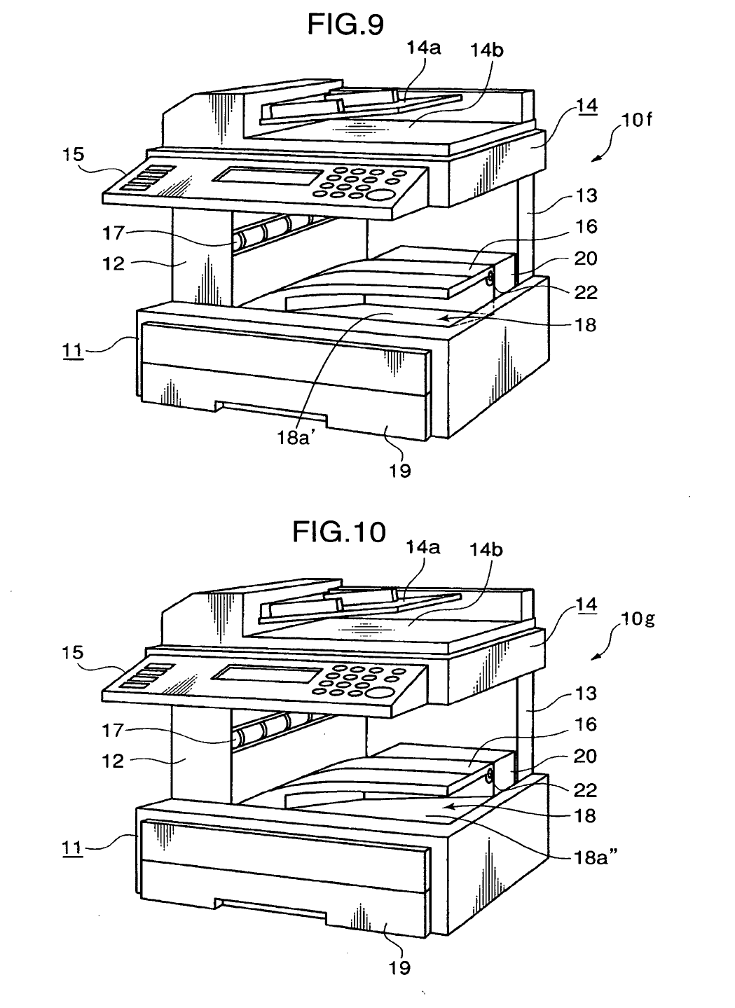

In seventh and eight embodiments, a slanted surface sloped down from the opening of the sheet storing portion 18 toward the back side is formed on the bottom plate of the sheet storing portion 18. FIG. 9 is a perspective view of an image forming apparatus 10f according to the seventh embodiment of the present invention. In the seventh embodiment, a bottom plate 18a′ of the sheet storing portion 18 is formed into a slanted surface sloped down from the front opening of the sheet storing portion 18 toward the rear surface portion 13. By adopting such a construction, a sheep P inserted into the sheet storing portion 18 slides toward the rear surface portion 13, wherefore the sheet P can be securely prevented from slipping down forward from the sheet storing portion 18.

FIG. 10 is a perspective view of an image forming apparatus 10g according to the eighth embodiment of the present invention. In the eighth embodiment, a bottom plate 18a″ of the sheet storing portion 18 is formed into a slanted surface sloped down from both the front opening of the sheet storing portion 18 and an opening thereof at one side toward the position of the intersection of the side wall portion 12 and the rear surface portion 13. By adopting such a construction, a sheep P inserted into the sheet storing portion 18 slides toward both the side wall portion 12 and the rear surface portion 13, wherefore the sheet P can be securely prevented from slipping down forward or rightward from the sheet storing portion 18.

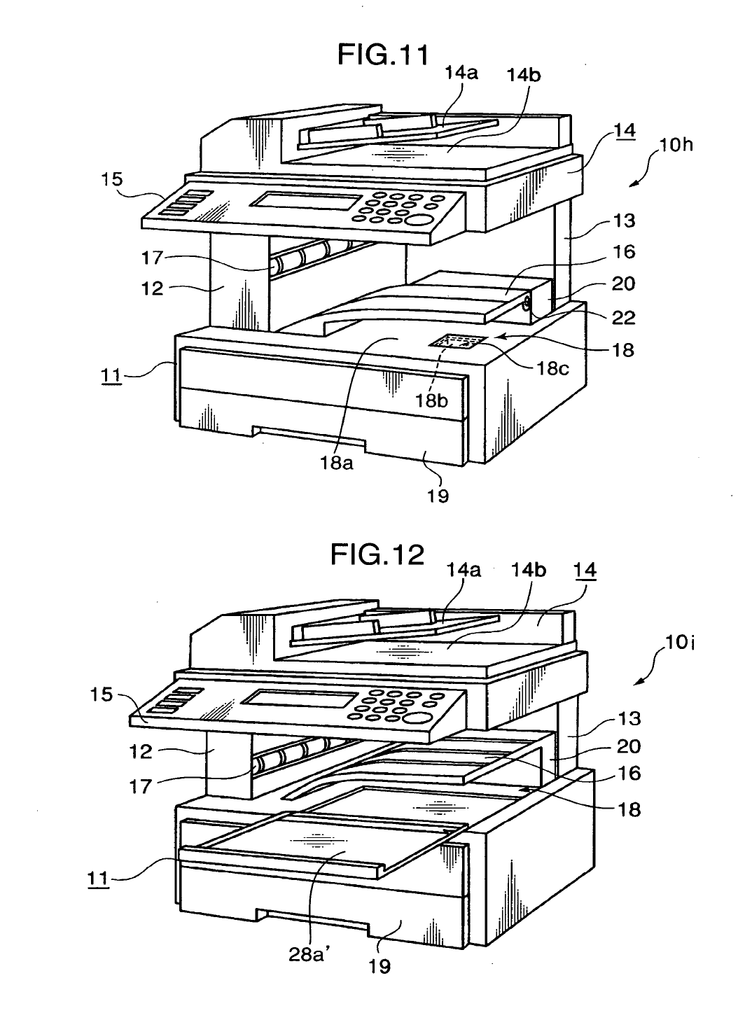

FIG. 11 is a perspective view of an image forming apparatus 10h according to a ninth embodiment of the present invention. In the ninth embodiment, an accommodation recess 18b for accommodating a business gadget such a hand stapler or scissors is formed at the front side of the bottom plate 18a of the sheet storing portion 18.

A lid 18c made of a transparent material such as a glass or a transparent synthetic resin is provided at an upper opening of the accommodation recess 18b, so that a gadget accommodated in the accommodation recess 18b can be visually confirmed. By providing such an accommodation recess 18b in the bottom plate 18a of the sheet storing portion 18, a user can conveniently immediately apply stapling or the like to discharged printed sheets P.

FIG. 12 is a perspective view of an image forming apparatus 10i according to a tenth embodiment of the present invention. In this image forming apparatus 10i of the tenth embodiment, a sheet tray 28′ movable along forward and backward directions by being guided by an unillustrated guiding member while being prevented from coming off is used instead of the sheet tray 28 of the fourth embodiment (FIG. 6) that is merely placed on the main body 11.

A movable range of the sheet tray 28′ is set such that the pulling end thereof can be withdrawn more forward than the front edge of the operation panel 15 projecting from the front surface of the image reader 14 through the front opening of the sheet storing portion 18.

The image forming apparatus 10i of the tenth embodiment having such a sheet tray 28′ is convenient in aligning a bundle of sheets because a user can utilize a part of the sheet tray 28′ projecting more forward than the operation panel 15, for example, as a work table for aligning the sheets with the sheet tray 28′ maximally withdrawn forward.

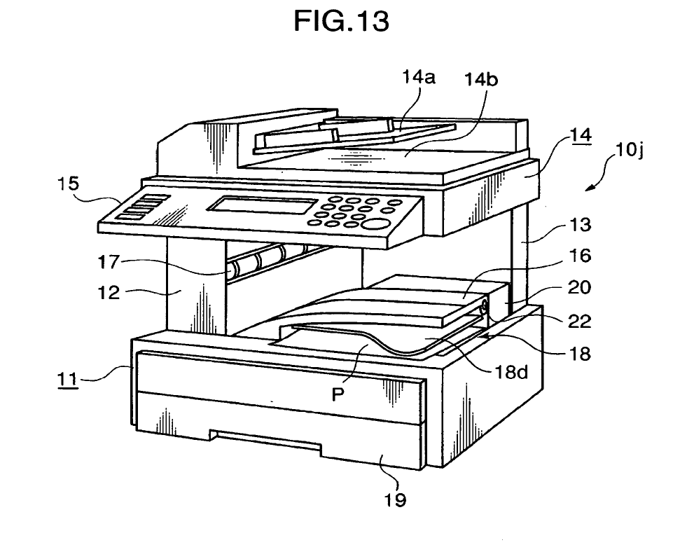

FIG. 13 is a perspective view of an image forming apparatus 10j according to an eleventh embodiment of the present invention. In the image forming apparatus 10j of the eleventh embodiment is provided a partition plate 18d for partitioning a storage space of the sheet storing portion 18 into a plurality of sections along height direction. The presence of such a partition plate 18d is convenient because sheets stored in the sheet storing portion 18 can be vertically sorted.

In the eleventh embodiment, the partition plate 18d is formed to have a wavy front edge by connecting portions concave and convex. By adopting such a wavy shape for the front edge of the partition plate 18d, fingers can be easily inserted above and below the partition plate 18d, wherefore the discharge tray 16 can be easily rotated upward or the sheets P can be easily inserted and removed.

In the foregoing embodiments, copiers are adopted as the image forming apparatuses 10, 10a to 10j. According to the present invention, the image forming apparatuses 10, 10a to 10j are not limited to copiers and may be facsimile apparatuses or printers having no image reader.

The discharge tray 16 is desirably made of a transparent material as described above or formed with a window portion at a suitable position for visual confirmation so that the presence of sheet(s) in the sheet storing portion 18 can be easily visually confirmed. This window portion may be formed by a through hole formed in the discharge tray 16 or a partially fitted transparent plate or the like. By adopting the above arrangements, the presence of sheet(s) in the sheet storing portion 18 can be more easily noticed.

This application is based on patent application Nos. 2005-54994 and 2006-17145 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus, comprising:
a main body accommodating at least an image forming unit and a fixing unit,
a discharging unit including a discharge tray onto which a recording sheet is discharged after an image is formed thereon in the main body, and
a sheet storing portion formed between the upper surface of the main body and the discharge tray for accommodating at least a part of the recording sheet to thereby hold the sheet,
wherein the sheet storing portion has a specified opening for allowing the recording sheet to be stored into and removed from the sheet storing portion through the opening; and
the discharge tray is rotatably supported at an end opposite to the opening.

2. An image forming apparatus according to claim 1, wherein the discharge tray is rotated upward due to the interference of a user's hand inserted through the opening, thereby widening the opening.

3. An image forming apparatus according to claim 1, further comprising
a discharge opening disposed in the discharging unit and through which the recording sheets are discharged in such a manner that an entirety of each respective recording sheet is discharged directly onto the discharge tray of the discharge unit;
wherein the discharge tray is above the sheet storing portion in such a manner to cover the sheet storing portion and to prevent the recording sheet discharged through the discharge opening from corning into the sheet storing portion.

4. An image forming apparatus according to claim 3, wherein the discharge tray is rotated upward due to the interference of a user's hand inserted through the opening, thereby widening the opening.

5. An image forming apparatus according to claim 3, further comprising
a member between the upper surface of the main body and the discharge tray for securing a specified space for the sheet storing portion.
